(19) United States
(12) Patent Application Publication
(10) Pub. No.: US 2026/0246578 A1
(43) Pub. Date: Aug. 20, 2026

(54) DOWNLINK REFERENCE TIMING DETERMINATION FOR MULTIPLE TIMING ADVANCES IN MULTI-DCI/MULTI-TRP

(71) Applicant: QUALCOMM Incorporated, San Diego, CA (US)

(72) Inventors: Shaozhen GUO, Beijing (CN); Mostafa KHOSHNEVISAN, San Diego, CA (US); Jing SUN, San Diego, CA (US); Xiaoxia ZHANG, San Diego, CA (US)

(21) Appl. No.: 18/874,564

(22) PCT Filed: Jul. 29, 2022
(86) PCT No.: PCT/CN2022/108805

§ 371 Date: Dec. 12, 2024

(51) Int. Cl. H04L 5/00

(52) U.S. Cl. CPC H04L 5/0044; H04L 5/0026

(57) ABSTRACT

Method and apparatus to determine downlink reference timing for multiple timing advances (TAs). The apparatus determines one or more DL RSs for a corresponding CORESET pool index value. The apparatus determines a downlink reference timing associated with a CORESET pool index based at least on at least one path corresponding to the one or more DL RSs. The apparatus transmits an uplink communication associated with the CORESET pool index based on the downlink reference timing. The downlink reference timing is based on the at least one path being a strongest path that corresponds to the one or more DL RSs or an earliest path detected that corresponds to the one or more DL RSs of a corresponding downlink frame. The one or more DL RSs associated with the corresponding CORESET pool index value is based on a set of activated TCI states associated with the corresponding CORESET pool index value.

### TECHNICAL FIELD

The present disclosure relates generally to communication systems, and more particularly, to a configuration to determine downlink reference timing for multiple timing advances (TAs).

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be a device at a UE. The device may be a processor and/or a modem at a UE or the UE itself. The apparatus determines one or more downlink reference signals (DL RSs) for a corresponding control resource set (CORESET) pool index value. The apparatus determines a downlink reference timing associated with the CORESET pool index value based at least on at least one path corresponding to the one or more DL RSs. The apparatus transmits an uplink communication associated with the CORESET pool index value based on the downlink reference timing.

To the accomplishment of the foregoing and related ends, the one or more aspects comprise the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4A illustrates an example of a multi-DCI based mTRP system.

FIG. 4B illustrates an example of different values of CORESETPoolIndex for a serving cell.

FIG. 5 illustrates an example of an additional PCI configuration.

FIG. 6 illustrates an example of an association between PCI and CORESETPoolIndex.

FIG. 7 illustrates an example of UE transmit timing.

FIG. 8 illustrates an example of two timing advances for uplink multi-DCI for mTRP.

FIG. 9 illustrates an example of an activated TCI state change during a downlink frame.

FIG. 10 illustrates an example of a change of an additional PCI during a downlink frame.

FIG. 11 illustrates an example of a change of an additional PCI during a downlink frame.

FIG. 12 is a call flow diagram of signaling between a UE and a base station.

FIG. 13 is a flowchart of a method of wireless communication.

FIG. 14 is a diagram illustrating an example of a hardware implementation for an example apparatus and/or network entity.

### DETAILED DESCRIPTION

In wireless communications, such as in multi-DCI based multi-TRP system, a DCI may be transmitted to a UE from each of the TRPs. Each CORESET may be configured with a CORESETPoolIndex value. The value of the CORESETPoolIndex value may be 0 or 1, which may group the CORESETs into two groups. For multi-DCI mTRP operation with two timing advances, two downlink reference timings may be considered or one downlink reference timing may be considered. In instances where two downlink reference timings are considered, an issue that is present is the determination of the downlink reference timing for each TRP. In instances for inter-cell mTRP, an issue that is present is the determination of downlink reference timing per PCI.

Aspects presented herein provide a configuration to determine downlink reference timing for multiple timing advances in multi-DCI mTRP operation. The determination of the downlink reference timing for multiple timing advances allows for uplink transmissions to be transmitted to different TRPs based on the respective downlink reference timing. In instances of inter-cell mTRP operation, the determination of the downlink reference timing may be based on a per PCI basis.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can comprise a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

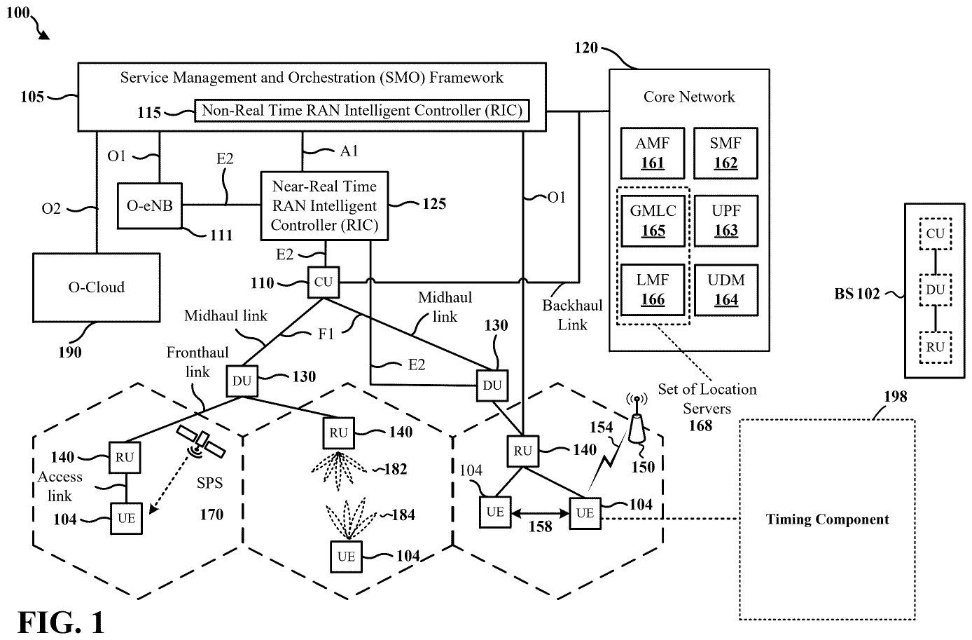

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUS 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface).

For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via O1) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base stations 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth, Wi-Fi based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like.

When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHZ) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a transmit reception point (TRP), network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the serving base station 102. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may comprise a timing component 198 configured to determine one or more DL RSs for a corresponding CORESET pool index value; determine a downlink reference timing associated with the CORESET pool index value based at least on at least one path corresponding to the one or more DL RSs; and transmit an uplink communication associated with the CORESET pool index value based on the downlink reference timing.

Although the following description may be focused on 5G NR, the concepts described herein may be applicable to other similar areas, such as LTE, LTE-A, CDMA, GSM, and other wireless technologies.

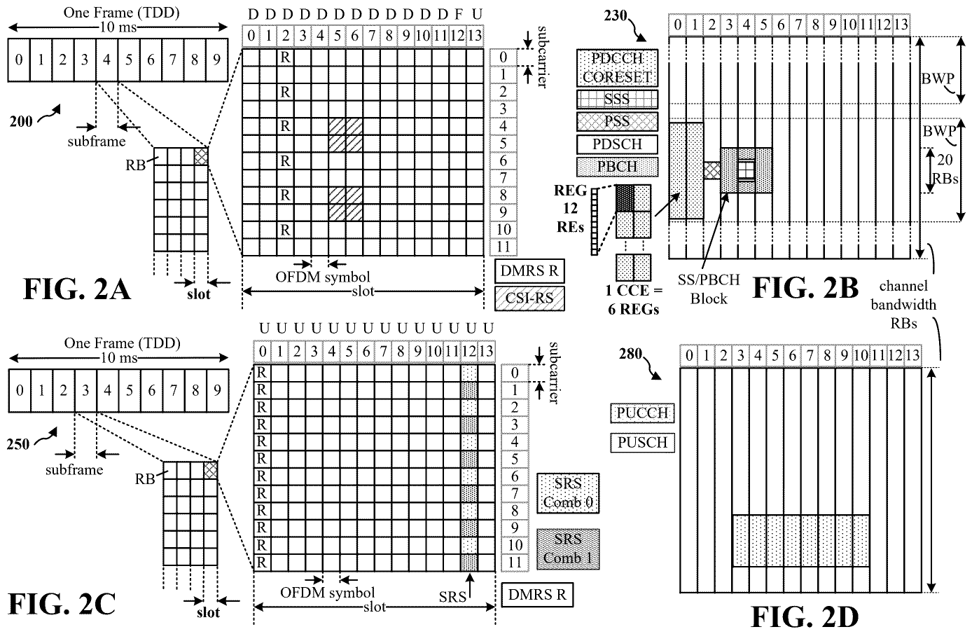

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| μ | SCS Δf = 2^{μ} · 15[kHz] | Cyclic prefix |
|---|---|---|
| 0 | 15 | Normal |
| 1 | 30 | Normal |
| 2 | 60 | Normal, Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology u, there are 14 symbols/slot and 24 slots/subframe. The subcarrier spacing may be equal to 24*15 kHz, where u is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology u=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

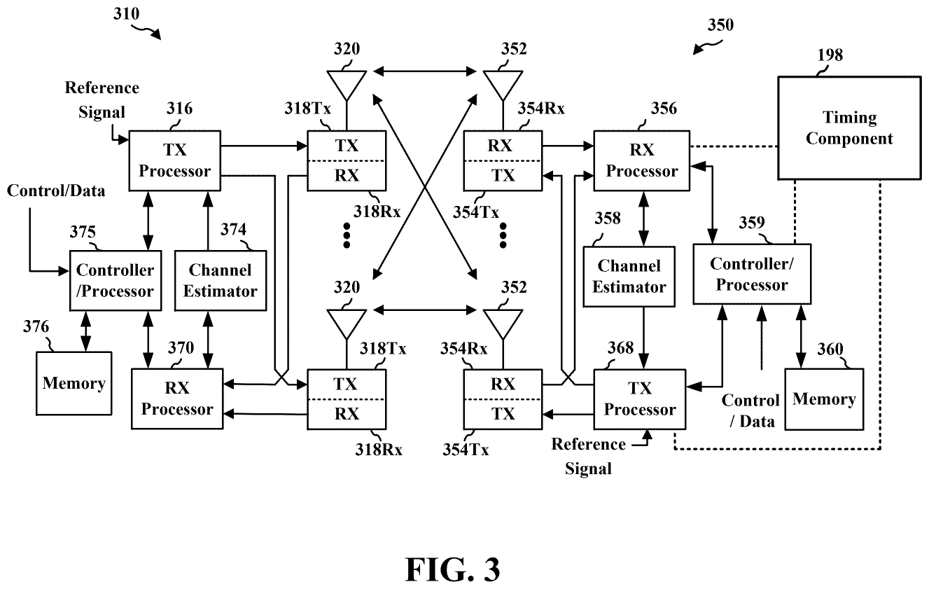

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the timing component 198 of FIG. 1.

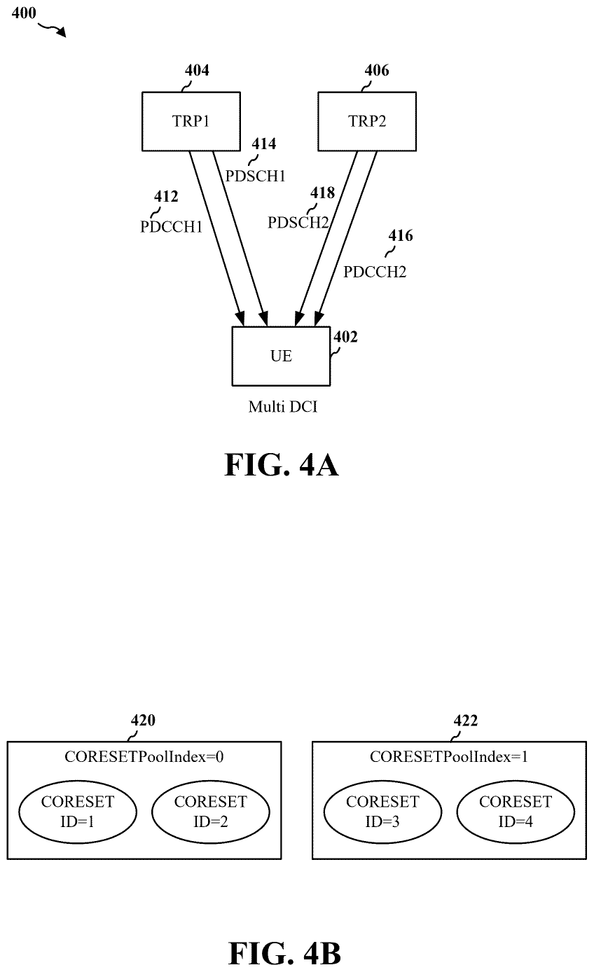

In wireless communications, such as in multi-DCI based multi-TRP system, a DCI may be transmitted to a UE from each of the TRPs. For example, with reference to diagram 400 of FIG. 4A, a TRP1 404 may transmit a first PDCCH1 412 to the UE 402 to schedule a PDSCH1 414, while a TRP2 406 may transmit a second PDCCH2 416 to the UE 402 to schedule a PDSCH2 418. TRP differentiation at the UE may be based on CORESETPoolIndex. Each CORESET may be configured with a CORESETPoolIndex value. The value of the CORESETPoolIndex value may be 0 or 1, which may group the CORESETs into two groups, while different TRPs or TRPs having different CORESETPoolIndex values are transparent to the UE. FIG. 4B is directed to instances where a UE is configured by a higher layer parameter (e.g., PDCCH-Config) that contains two different values of CORESETPoolIndex in CORESETs for the active bandwidth part of a serving cell. For example, CORESETPoolIndex 420 may have a value of 0, while CORESETPoolIndex 422 may have a value of 1. The CORESETPoolIndex 420 may comprise the CORESET IDs of 1 and 2, while the CORESETPoolIndex 422 may comprise the CORESET IDs of 3 and 4. In some instances, different TRPs may have the same PCI (e.g., intra-cell), where different panels or remote radio head (RRH) of the same cell or base station. In some instances, different TRPs may have different PCIs (e.g., inter-cell), where from the UE's point of view, multi-TRP is defined in a given serving cell, but the UE is only aware of one PCI, namely the PCI that the UE acquired during the cell search procedure.

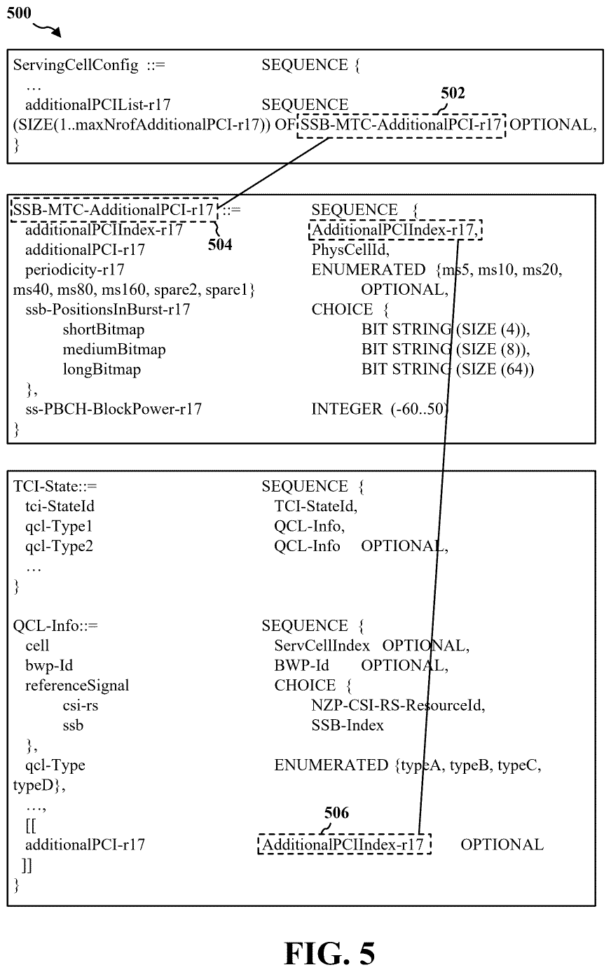

In inter-cell mTRP, a maximum number of additional RRC configured PCIs per component carrier (CC) may be denoted X and may be reported as a UE capability. In some instances, support for two independent X values (e.g., X1, X2) may be reported as a UE capability for two different assumptions on additional SSB time domain positions and periodicity with respect to the serving cell SSB. For example, in a first case X1 may equal the maximum number of configured additional PCIs when each configuration of SSB time domain positions and periodicity of the additional PCIs is the same as SSB time domain positions and periodicity of the serving cell PCI. In a second case X2 may equal the maximum number of configured additional PCIs when the configurations of SSB time domain positions and periodicity of the additional PCIs is not according to the first case X1. The first case X1 and the second case X2 may be not enabled simultaneously. From an RRC signaling perspective, the number of configured additional PCIs may comprise {1, 2, 3, 4, 5, 6, 7}. The UE capability may have FR1 and FR2 differentiation. A center frequency, SCS, SFN offset may be assumed to be the same for SSBs from the serving cell and the configured SSBs with different PCI from the serving cell for inter-cell mTRP operation. A new RRC indicator/signalling (e.g., re-index the non-serving cell) was introduced to indicate the non-serving cell information that a TCI state/QCL information is associated with, where the new indicator/signaling is not the exact PCI value. For example, with reference to diagram 500 of FIG. 5, to support the inter-cell mTRP, each serving cell may be configured with multiple additional PCIs (e.g., SSB-MTC-AdditionalPCI-r17 502), and for each additional PCI, SSB related information (e.g., SSB-MTC-AdditionalPCI-r17 504) related to measurement may be configured. In the TCI state, each TCI may be associated with a reference signal, and the reference signal may come from the SSB from the serving cell or another cell. If the SSB is from the serving cell, then the SSB may be associated with the serving cell PCI. If the SSB is from another cell, such as the additional PCI, then in the TCI state, the SSB will be associated with the additional PCI index (e.g., AdditionalPCIIndex-r17 506), which will be mapped to the additional PCI.

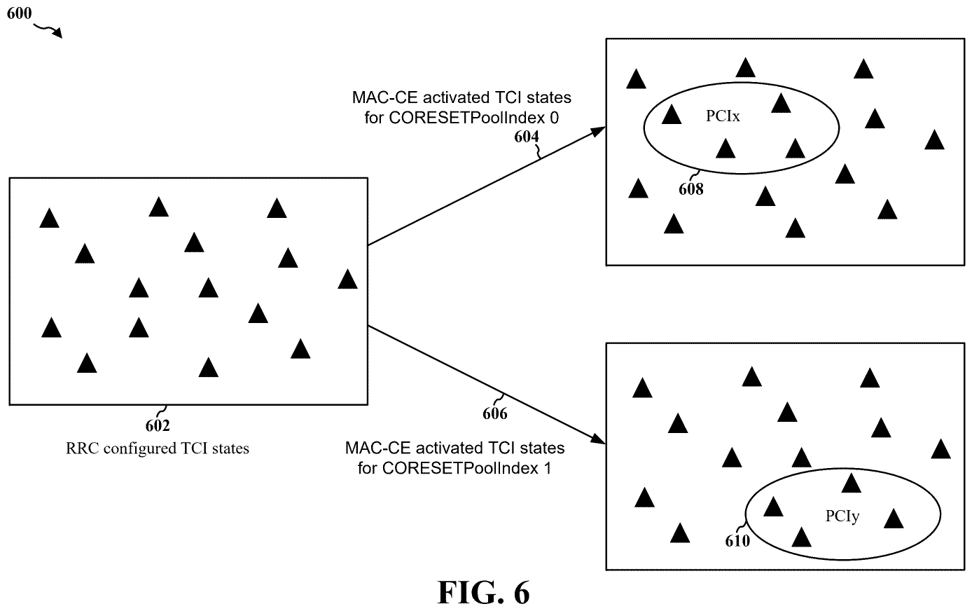

The serving cell PCI is associated with active TCI states, and only 1 additional PCI may be associated with the active TCI states. For inter-cell mTRP, one PCI may be associated with one or more of the activated TCI states for PDSCH/PDCCH associated with one CORESETPoolIndex, while another PCI associated with one or more of the activated TCI states for PDSCH/PDCCH may be associated with another CORESETPoolIndex. For example, with reference to diagram 600 of FIG. 6, TCI states 602 may be configured via RRC signalling. A MAC-CE 604 may be transmitted to activate TCI states for a CORESETPoolIndex value of 0, such that PCIx 608 may be associated with the active TCI states. In another example, a MAC-CE 606 may be transmitted to activate TCI states for a CORESETPoolIndex value of 1, such that PCIy 610 may be associated with the active TCI states. In some instances, at least one of PCIx 608 and PCly 610 may be the serving cell PCI. In some instances, at most one of PCIx 608 and PCIy 610 may be the additional PCI (e.g., non-serving cell PCI).

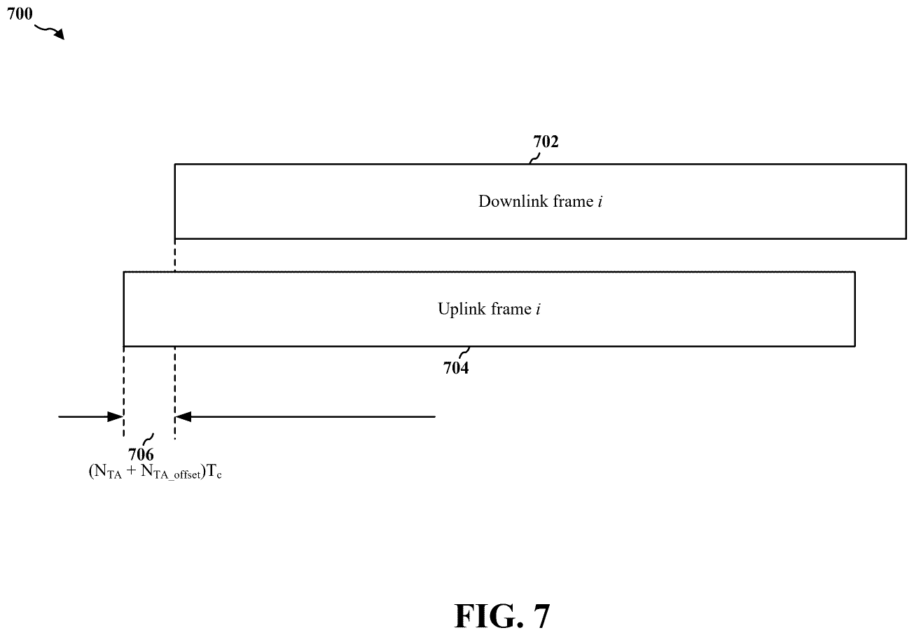

FIG. 7 illustrates an example of UE transmit timing. The diagram 700 of FIG. 7 includes a downlink frame i 702 and an uplink frame i 704. The UE shall have capability to follow the frame timing change of the reference cell in a connected state. The uplink frame transmission takes place (N_{TA}+N_{TA_offset})*Tc 706 before the reception of the first detected path (in time) of the corresponding downlink frame from the reference cell. For serving cell(s) in the primary timing advance group (pTAG), UE shall use the special cell (SpCell) as the reference cell for deriving the UE transmit timing for cells in the pTAG. For serving cell(s) in the secondary timing advance group (sTAG), UE shall use any of the activated secondary cells (SCells) as the reference cell for deriving the UE transmit timing for the cells in the sTAG. UE initial transmit timing accuracy and gradual timing adjustment requirements are defined.

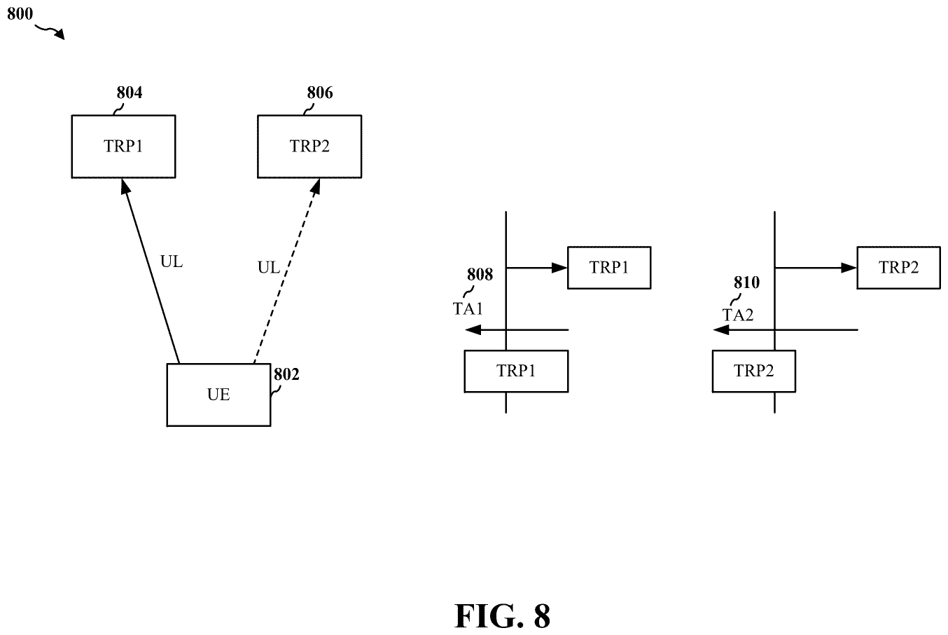

FIG. 8 illustrates an example of two timing advances for uplink multi-DCI for mTRP operation. The diagram 800 of FIG. 8 includes a UE 802, a first TRP1 804, and a second TRP2 806. The UE 802 may transmit uplink data to the first TRP1 804 and the second TRP2 806. The timing advances are configured to account for different propagation delays to the two TRPs in case of multi-DCI for mTRP. For example, a first timing advance TA1 808 may account for propagation delay between the UE 802 and the first TRP1 804, while the second timing advance TA2 810 may account for propagation delay between the UE 802 and the second TRP2 806. The timing advances TA1 808 and TA2 810 may be the same or different. The timing advances TA1 808 and TA2 810 are with respect to the reference timing for the downlink reception.

For multi-DCI mTRP operation with two timing advances, two downlink reference timings may be considered or one downlink reference timing may be considered. In instances where two downlink reference timings are considered, an issue that is present is the determination of the downlink reference timing for each TRP. In instances for inter-cell mTRP, an issue that is present is the determination of downlink reference timing per PCI.

Aspects presented herein provide a configuration to determine downlink reference timing for multiple timing advances in multi-DCI mTRP operation. The determination of the downlink reference timing for multiple timing advances allows for uplink transmissions to be transmitted to different TRPs based on the respective downlink reference timing, where the uplink transmissions account for propagation delays per each TRP. In instances of inter-cell mTRP operation, the determination of the downlink reference timing may be based on a per PCI basis.

In some instances, the downlink reference timing per TRP may be determined based on the strongest or earliest path detected from DL RS(s) associated with the corresponding CORESETPoolIndex value. The strongest path may be based on signal strength and/or quality, such as but not limited to RSSI or RSRP. The earliest path may be the earliest path detected in time, such as the first detected path. The DL RSs associated with a corresponding CORESETPoolIndex value may be determined based on a set of activated TCI states associated with the corresponding CORESETPoolIndex value. The set of activated TCI states associated with the corresponding CORESETPoolIndex value may be based on at least one of activated TCI states for PDSCH for that CORESETPoolIndex value, activated TCI states for CORESETs associated with that CORESETPoolIndex value, or the union of activated TCI states for PDSCH for that CORESETPoolIndex value and activated TCI states for CORESETs associated with that CORESETPoolIndex value. In some instances, among all the DL RSs in the set of activated TCI states, only DL RSs having a QCL-type set to typeD may be considered as DL RSs for DL reference timing determination.

In some instances, the DL RSs associated with a corresponding CORESETPoolIndex value may be determined based on a particular TCI state associated with the corresponding CORESETPoolIndex value, which may be based on at least one of the activated TCI state with lowest or highest TCI state ID among the activated TCI states for PDSCH for that CORESETPoolIndex value, the activated TCI state of lowest or highest CORESET ID associated with that CORESETPoolIndex value, or TCI states for PDCCH receptions in CORESETs associated with that CORESETPoolIndex value and associated with the search space sets with the shortest monitoring periodicity. If more than one CORESETs are associated with search space sets having the shortest monitoring periodicity, the particular TCI state associated with the corresponding CORESETPoolIndex value, may be based on the CORESET with highest or lowest CORESET ID among the more than one CORESETs. In some instances, if the particular TCI state includes two DL RSs, only DL RSs having a QCL-type set to typeD may be considered as a DL RS.

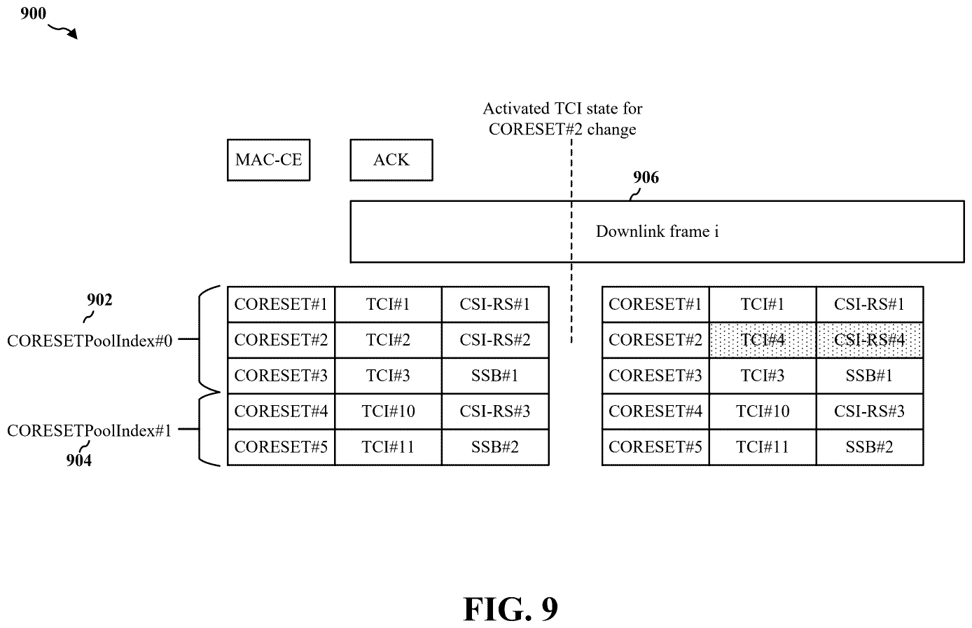

In some aspects, the set of activated TCI states or particular TCI state may be changed in the middle of a downlink frame. In such instances, the DL RSs associated with a corresponding CORESETPoolIndex value are determined based on the set of activated TCI states or the particular TCI state in the first slot of that DL frame. For example, with reference to diagram 900 of FIG. 9, for CORESETPoolIndex 902 having a value of 0, CSI-RS #1, CSI-RS #2, and SSB #1 may be considered as DL RSs for the first downlink reference timing determination. For CORESETPoolIndex 904 having a value of 1, CSI-RS #3, SSB #2 may be considered as DL RSs for the second downlink reference timing determination. The activated TCI state TCI #2 for CORESET #2 associated with CORESETPoolIndex 902 changes to TCI #4 during the DL frame i 906. However, CSI-RS #2 is the DL RS associated with the corresponding CORESETPoolIndex value and TCI #2 in the first slot of the DL frame i 906, such that CSI-RS #4 is not considered as the DL RS after the change during the DL frame i 906.

In some aspects, if the UE has not received a MAC-CE activation command for any PDSCH for that CORESETPoolIndex and/or if UE has not received a MAC-CE activation command for any CORESET associated with that CORESETPoolIndex value, then the UE may determine the DL reference timing associated with that CORESETPoolIndex value based on the strongest or earliest path detected from SSB the UE identified during a PRACH procedure associated with the corresponding CORESETPoolIndex value. The association between PRACH and CORESETPoolIndex value may be determined based on a fixed rule. For example, a first half of SSBs are associated with the first CORESETPoolIndex value, while a second half SSBs are associated with the second CORESETPoolIndex value. The association between PRACH or SSB and CORESETPoolIndex value may be configured via RRC signaling. The association between PRACH and CORESETPoolIndex value may be based on a CORESETPoolIndex value of the CORESET in which a PDCCH order is received.

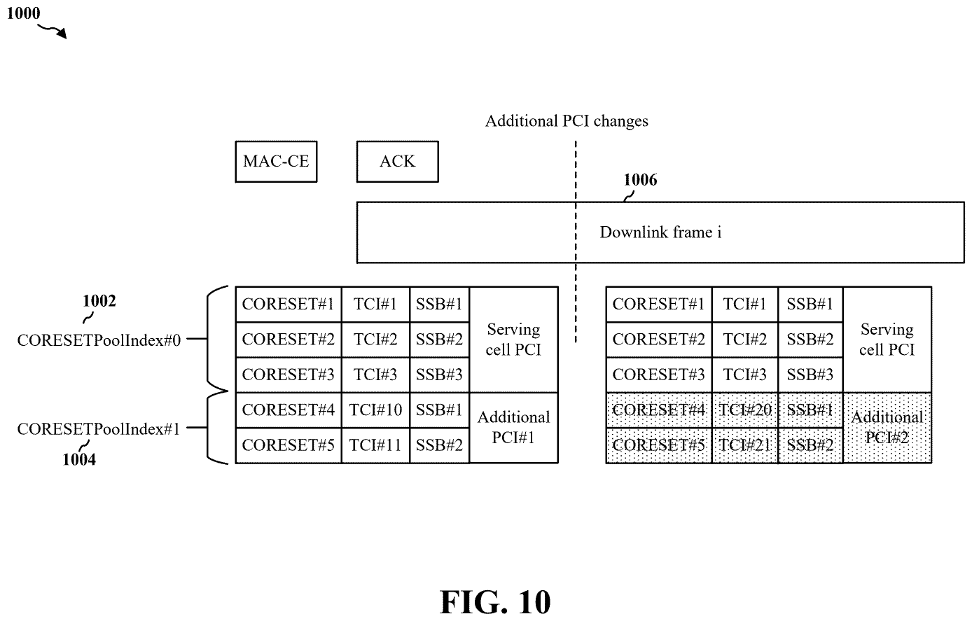

In some aspects, for example inter-cell mTRP, if the additional PCI associated with the activated TCI states of PDCCH/PDSCH for a given CORESETPoolIndex value is changed in the middle of a DL frame. In such instances, the downlink reference timing for the given CORESETPoolIndex value may be determined based on the additional PCI associated with the activated TCI states of PDCCH/PDSCH in the first slot of that downlink frame. For example, with reference to diagram 1000 of FIG. 10, two downlink reference timings may be considered where each is associated with one CORESETPoolIndex value. For CORESETPoolIndex 1002 having a value of 0, SSB #1, SSB #2, and SSB #3 associated with serving cell PCI may be considered as DL RSs for a first downlink reference timing determination. For CORESETPoolIndex 1004 having a value of 1, SSB #1 and SSB #2 associated with additional PCI #1 may be considered as DL RSs for a second downlink reference timing determination. The additional PCI may change during the downlink frame i 1006, but SSB #1 and SSB #2 associated with additional PCI #2 are not considered as DL RSs because the activated TCI states in the first slot of the downlink frame i 1006 are TCI #10 and TCI #11 associated with additional PCI #1.

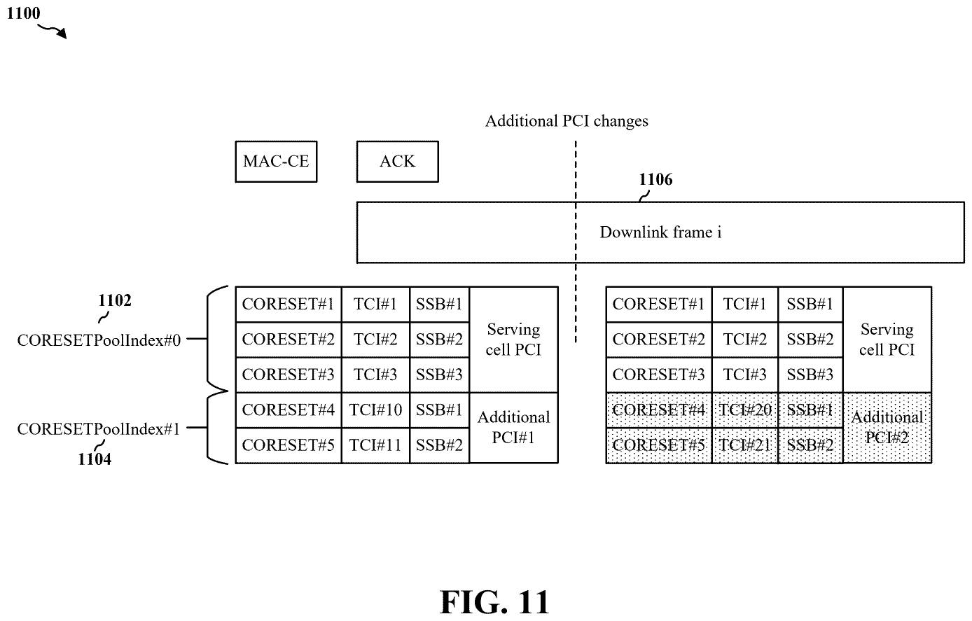

In some aspects, if the additional PCI associated with the activated TCI states of PDCCH/PDSCH for a given CORESETPoolIndex value is changed in the middle of a downlink frame, a downlink reference timing may be determined on a per PCI basis. The downlink reference timing per PCI may be determined based on the strongest or earliest path detected from DL RS(s) associated with the corresponding PCI. The DL RSs associated with a corresponding PCI may be determined based on a set of activated TCI states associated with the corresponding PCI, which may be based on at least one of activated TCI states of PDSCH associated with that PCI, activated TCI states of CORESETs associated with that PCI, or a union of activated TCI states of PDSCH and CORESETs associated with that PCI. In some instances, among all the DL RSs in the set of activated TCI states, only DL RSs having a QCL-Type set of typeD may be considered as DL RSs for downlink reference timing determination. For example, with reference to diagram 1100 of FIG. 11, two DL reference timings may be considered where each is associated with one CORESETPoolIndex value. For CORESETPoolIndex 1102 having a value of 0, SSB #1, SSB #2, and SSB #3 associated with serving cell PCI may be considered as DL RSs for a first downlink reference timing determination. For CORESETPoolIndex 1104 having a value of 1, SSB #1 and SSB #2 associated with additional PCI #1 may be considered as DL RSs for a second reference timing determination. The additional PCI may change during the downlink frame i 1106, in this case, SSB #1 and SSB #2 associated with additional PCI #2 are considered as DL RSs for CORESETPoolIndex 1104 after the additional PCI change. However, before additional PCI changes, SSB #1 and SSB #2 associated with additional PCI #1 are considered as DL RSs for CORESETPoolIndex 1104.

In some aspects, the DL RSs associated with the corresponding PCI may be determined based on a particular TCI state associated with the corresponding PCI, which may be based on at least one of the activated TCI state with lowest or highest TCI state ID among the activated TCI states of PDSCH associated with that PCI, the activated TCI state of lowest or highest CORESET ID among the CORESETs whose activated TCI states are associated with that PCI, or activated TCI states for PDCCH receptions in CORESETs whose activated TCI states are associated with that PCI and associated with the search space sets with shortest monitoring periodicity. If more than one CORESETs are associated with search space sets having the shortest monitoring periodicity, the particular TCI state associated with the corresponding PCI, may be based on the CORESET with highest or lowest CORESET ID among the more than one CORESETs. In some instances, if the particular TCI state include two DL RSs, only the DL RS with a QCL-Type set to typeD may be considered as DL RSs.

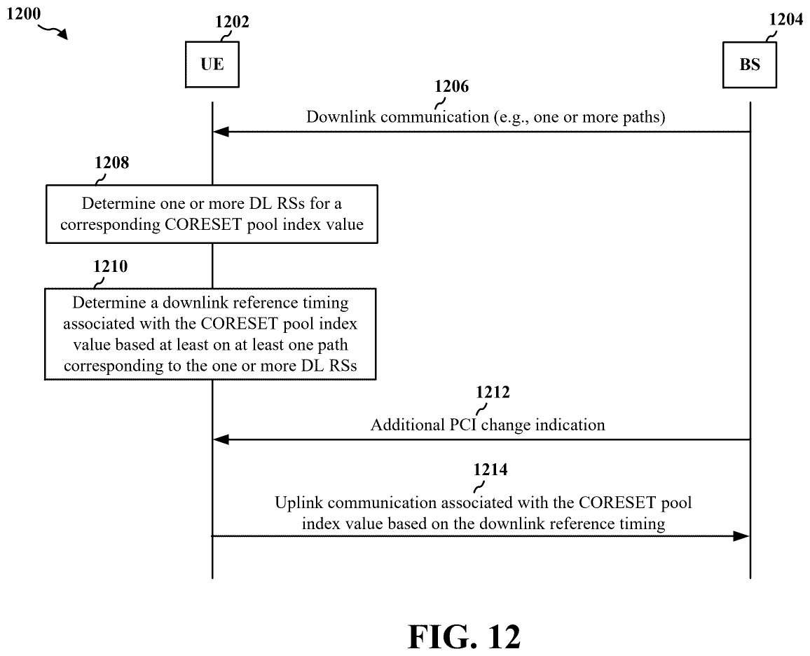

FIG. 12 is a call flow diagram 1200 of signaling between a UE 1202 and a base station 1204. The base station 1204 may be configured to provide at least one cell. The UE 1202 may be configured to communicate with the base station 1204. For example, in the context of FIG. 1, the base station 1204 may correspond to base station 102 and. Further, a UE 1202 may correspond to at least UE 104. In another example, in the context of FIG. 3, the base station 1204 may correspond to base station 310 and the UE 1202 may correspond to UE 350.

At 1206, the UE 1202 may receive downlink communication from the base station 1204. For example, the downlink communication may comprise signaling related to establishing a connection with the base station, such as but not limited to a PRACH procedure. During reception of the downlink communication, the UE 1202 may detect and/or measure one or more downlink paths.

At 1208, the UE may determine one or more DL RSs for a corresponding CORESET pool index value. The UE may determine the one or more DL RSs from the base station 1204. In some aspects, the one or more DL RSs associated with the corresponding CORESET pool index value may be based on a set of activated TCI states associated with the corresponding CORESET pool index value. In some aspects, the set of activated TCI states associated with the corresponding CORESET pool index value may be based on activated TCI states of a PDSCH associated with the CORESET pool index value. In some aspects, the set of activated TCI states associated with the corresponding CORESET pool index value may be based on activated TCI states of CORESETs associated with the CORESET pool index value. In some aspects, the set of activated TCI states associated with the corresponding CORESET pool index value may be based on a union of activated TCI states of a PDSCH associated with the CORESET pool index value and activated TCI states of CORESETs associated with the CORESET pool index value. In some aspects, the one or more DL RSs may comprise a quasi co-location (QCL) type set to a first setting. The first setting may comprise at least a typeD setting. The first setting may comprise settings other than the typeD setting and the disclosure is not intended to be limited to the aspects disclosed herein. In some aspects, the one or more DL RSs associated with the corresponding CORESET pool index value may be based on a TCI state associated with the corresponding CORESET pool index value. In some aspects, the TCI state associated with the corresponding CORESET pool index value may be based on an activated TCI state having a first TCI state within a plurality of activated TCI states of a PDSCH associated with the CORESET pool index value. The first TCI state is the TCI state with lowest or highest TCI state ID among the plurality of activated TCI states of PDSCH associated with the CORESET pool index value. In some aspects, the TCI state associated with the corresponding CORESET pool index value may be based on an activated TCI state of a CORESET having a first CORESET identifier (ID) associated with the CORESET pool index value. The first CORESET identifier may be the lowest or highest CORESET identifier associated with the CORESET pool index. In some aspects, the TCI state associated with the corresponding CORESET pool index value may be based on activated TCI states of PDCCH receptions in CORESETs associated with the CORESET pool index value and associated with search space sets having a shortest monitoring periodicity. In some aspects, the set of activated TCI states associated with the corresponding CORESET pool index value may be comprised of activated TCI states associated with the corresponding CORESET pool index in a first slot of the downlink frame, if a MAC CE activation command to update the set of activated transmission configuration indication states is applied in the middle of the downlink frame.

At 1210, the UE 1202 may determine a downlink reference timing associated with the CORESET pool index value. The UE 1202 may determine the downlink reference timing associated with the CORESET pool index value based at least on at least one path corresponding to the one or more DL RSs. In some aspects, the downlink reference timing may be based on the at least one path being a strongest path that corresponds to the one or more DL RSs. The UE may detect and/or measure a plurality of paths that correspond to the one or more DL RSs and select the strongest path based on signal quality, signal strength, received signal strength indicator (RSSI), reference signal received power (RSRP), or the like. In some aspects, the downlink reference timing may be based on the at least one path being an earliest path detected that corresponds to the one or more DL RSs of a corresponding downlink frame. For example, the first path detected, in time, may be utilized to determine the downlink reference timing. In some aspects, the downlink reference timing may be based on a SSB received during a physical random access channel (PRACH) procedure. For example, the downlink reference timing may be based on the SSB received during the PRACH procedure if a MAC-CE activation command for a PDSCH that corresponds to a CORESET pool index or a MAC-CE activation command for any CORESET associated with the CORESET pool index value is not received. The downlink reference timing may be based on a strongest or an earliest path of a corresponding downlink frame detected from the SSB received during the PRACH procedure. In some aspects, an association between the PRACH procedure and the CORESET pool index value may be based on a fixed rule, where a first subset of SSBs are associated with a first CORESET pool index value and a second subset of SSBs are associated with a second CORESET pool index value. In some aspects, the association between the PRACH procedure and the CORESET pool index value may be configured via radio resource control (RRC) signaling. In some aspects, the association between the PRACH procedure and the CORESET pool index value may be based at least on a CORESET pool index of the CORESET in which a PDCCH that triggers the PRACH procedure is received.

In some aspects, for example at 1212, the UE 1202 may receive an additional physical cell identifier (PCI) change indication. The UE 1202 may receive the additional PCI change indication from the base station 1204. In some aspects, an additional physical cell identifier (PCI) associated with activated TCI states of at least one of a PDCCH or a PDSCH for the CORESET pool index value may be changed during a downlink frame. In such instances, the downlink reference timing for the CORESET pool index value may be based on the additional PCI associated with the CORESET pool index in a first slot of the downlink frame. In some aspects, the downlink reference timing for the CORESET pool index value may be based on a downlink reference timing of the additional PCI associated with the CORESET pool index. The downlink reference timing of the additional PCI associated with the CORESET pool index may be based on at least one of the strongest path or the earliest path detected from the DL RS(s) associated with the additional PCI. The DL RS(s) associated with the additional PCI may be based on a set of activated TCI states associated with the additional PCI. In some aspects, the set of activated TCI states associated with the additional PCI may be based on at least one of activated TCI states of the PDSCH associated with the additional PCI. In some aspects, the set of activated TCI states associated with the additional PCI may be based on activated TCI states of CORESETs associated with the additional PCI. In some aspects, the set of activated TCI states associated with the additional PCI may be based on a union of activated TCI states of the PDSCH and CORESETs associated with the additional PCI. In some aspects, the DL RS may comprise a quasi co-location (QCL) type set to a first setting. For example, the first setting may comprise a typeD setting. In some aspects, the first setting may comprise various different setting types and is not intended to be limited to the aspects disclosed herein. In some aspects, the DL RS associated with the additional PCI may be based on a TCI state associated with the additional PCI. The TCI state associated with the additional PCI may be based on an activated TCI state having a first TCI state identifier (ID) within a plurality of activated TCI state IDs of a PDSCH associated with the PCI. The TCI state associated with the additional PCI may be based on the activated TCI state of a CORESET having a first CORESET ID within a plurality of CORESET IDs having activated TCI states associated with the PCI. The TCI state associated with the additional PCI may be based on the activated TCI state for PDCCH receptions in CORESETs having activated TCI states associated with the PCI and search space sets having a shortest monitoring periodicity. In some aspects, the DL RS associated with the additional PCI may comprise a QCL type set to a first setting. For example, the first setting may comprise a typeD setting. In some aspects, the first setting may comprise various different setting types and is not intended to be limited to the aspects disclosed herein.

At 1214, the UE 1202 may transmit an uplink communication associated with the CORESET pool index value. The UE 1202 may transmit the uplink communication to the base station 1204. The base station 1204 may receive the uplink communication from the UE 1202. The UE may transmit the uplink communication associated with the CORESET pool index value based on the downlink reference timing.

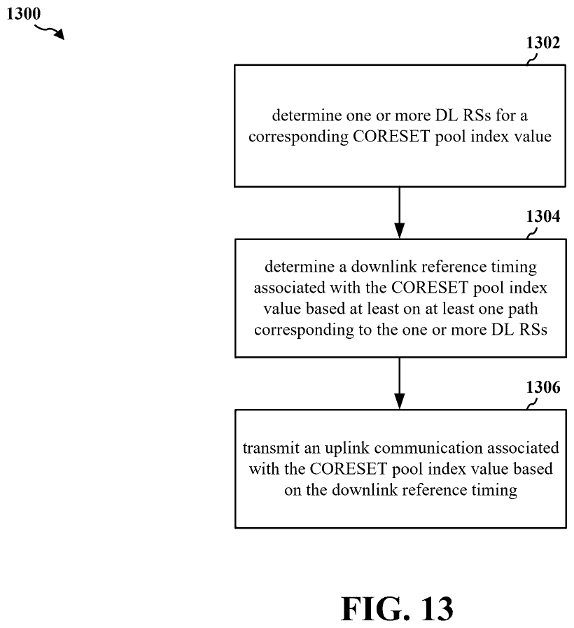

FIG. 13 is a flowchart 1300 of a method of wireless communication. The method may be performed by a UE (e.g., the UE 104; the apparatus 1404). One or more of the illustrated operations may be omitted, transposed, or contemporaneous. The method may allow a UE to determine a downlink timing reference for each TRP in a mTRP environment.

At 1302, the UE may determine one or more DL RSs for a corresponding CORESET pool index value. For example, 1302 may be performed by timing component 198 of apparatus 1404. In some aspects, the one or more DL RSs associated with the corresponding CORESET pool index value may be based on a set of activated TCI states associated with the corresponding CORESET pool index value. In some aspects, the set of activated TCI states associated with the corresponding CORESET pool index value may be based on activated TCI states of a PDSCH associated with the CORESET pool index value. In some aspects, the set of activated TCI states associated with the corresponding CORESET pool index value may be based on activated TCI states of CORESETs associated with the CORESET pool index value. In some aspects, the set of activated TCI states associated with the corresponding CORESET pool index value may be based on a union of activated TCI states of a PDSCH associated with the CORESET pool index value and activated TCI states of CORESETs associated with the CORESET pool index value. In some aspects, the one or more DL RSs may comprise a QCL type set to a first setting. The first setting may comprise at least a typeD setting. The first setting may comprise settings other than the typeD setting and the disclosure is not intended to be limited to the aspects disclosed herein. In some aspects, the one or more DL RSs associated with the corresponding CORESET pool index value may be based on a TCI state associated with the corresponding CORESET pool index value. In some aspects, the TCI state associated with the corresponding CORESET pool index value may be based on an activated TCI state having a first TCI state within a plurality of activated TCI states of a PDSCH associated with the CORESET pool index value. The first TCI state is the TCI state with lowest or highest TCI state ID among the plurality of activated TCI states of PDSCH associated with the CORESET pool index value. In some aspects, the TCI state associated with the corresponding CORESET pool index value may be based on an activated TCI state of a CORESET having a first CORESET identifier (ID) associated with the CORESET pool index value. The first CORESET identifier may be the lowest or highest CORESET identifier associated with the CORESET pool index. In some aspects, the TCI state associated with the corresponding CORESET pool index value may be based on activated TCI states of PDCCH receptions in CORESETs associated with the CORESET pool index value and associated with search space sets having a shortest monitoring periodicity. In some aspects, the set of activated TCI states associated with the corresponding CORESET pool index value may be comprised of activated TCI states associated with the corresponding CORESET pool index in a first slot of the downlink frame, if a MAC CE activation command to update the set of activated transmission configuration indication states is applied in the middle of the downlink frame.

At 1304, the UE may determine a downlink reference timing associated with the CORESET pool index value. For example, 1304 may be performed by timing component 198 of apparatus 1404. The UE may determine the downlink reference timing associated with the CORESET pool index value based at least on at least one path corresponding to the one or more DL RSs. In some aspects, the downlink reference timing may be based on the at least one path being a strongest path that corresponds to the one or more DL RSs. The UE may detect and/or measure a plurality of paths that correspond to the one or more DL RSs and select the strongest path based on signal quality, signal strength, RSSI, RSRP, or the like. In some aspects, the downlink reference timing may be based on the at least one path being an earliest path detected that corresponds to the one or more DL RSs of a corresponding downlink frame. For example, the first path detected, in time, may be utilized to determine the downlink reference timing. In some aspects, the downlink reference timing may be based on a SSB received during a PRACH procedure. For example, the downlink reference timing may be based on the SSB received during the PRACH procedure if a MAC-CE activation command for a PDSCH that corresponds to a CORESET pool index or a MAC-CE activation command for any CORESET associated with the CORESET pool index value is not received. The downlink reference timing may be based on a strongest or an earliest path of a corresponding downlink frame detected from the SSB received during the PRACH procedure. In some aspects, an association between the PRACH procedure and the CORESET pool index value may be based on a fixed rule, where a first subset of SSBs are associated with a first CORESET pool index value and a second subset of SSBs are associated with a second CORESET pool index value. In some aspects, the association between the PRACH procedure and the CORESET pool index value may be configured via RRC signaling. In some aspects, the association between the PRACH procedure and the CORESET pool index value may be based at least on a CORESET pool index of the CORESET in which a PDCCH that triggers the PRACH procedure is received.

In some aspects, an additional PCI associated with activated TCI states of at least one of a PDCCH or a PDSCH for the CORESET pool index value may be changed during a downlink frame. In such instances, the downlink reference timing for the CORESET pool index value may be based on the additional PCI associated with the CORESET pool index in a first slot of the downlink frame. In some aspects, the downlink reference timing for the CORESET pool index value may be based on a downlink reference timing of the additional PCI associated with the CORESET pool index. The downlink reference timing of the additional PCI associated with the CORESET pool index may be based on at least one of the strongest path or the earliest path detected from the DL RS(s) associated with the additional PCI. The DL RS(s) associated with the additional PCI may be based on a set of activated TCI states associated with the additional PCI. In some aspects, the set of activated TCI states associated with the additional PCI may be based on at least one of activated TCI states of the PDSCH associated with the additional PCI. In some aspects, the set of activated TCI states associated with the additional PCI may be based on activated TCI states of CORESETs associated with the additional PCI. In some aspects, the set of activated TCI states associated with the additional PCI may be based on a union of activated TCI states of the PDSCH and CORESETs associated with the additional PCI. In some aspects, the DL RS may comprise a QCL type set to a first setting. For example, the first setting may comprise a typeD setting. In some aspects, the first setting may comprise various different setting types and is not intended to be limited to the aspects disclosed herein. In some aspects, the DL RS associated with the additional PCI may be based on a TCI state associated with the additional PCI. The TCI state associated with the additional PCI may be based on an activated TCI state having a first TCI state identifier (ID) within a plurality of activated TCI state IDs of a PDSCH associated with the PCI. The TCI state associated with the additional PCI may be based on the activated TCI state of a CORESET having a first CORESET ID within a plurality of CORESET IDs having activated TCI states associated with the PCI. The TCI state associated with the additional PCI may be based on the activated TCI state for PDCCH receptions in CORESETs having activated TCI states associated with the PCI and search space sets having a shortest monitoring periodicity. In some aspects, the DL RS associated with the additional PCI may comprise a QCL type set to a first setting. For example, the first setting may comprise a typeD setting. In some aspects, the first setting may comprise various different setting types and is not intended to be limited to the aspects disclosed herein.

At 1306, the UE may transmit an uplink communication associated with the CORESET pool index value. For example, 1306 may be performed by timing component 198 of apparatus 1404. The UE may transmit the uplink communication to a network entity. The UE may transmit the uplink communication associated with the CORESET pool index value based on the downlink reference timing.

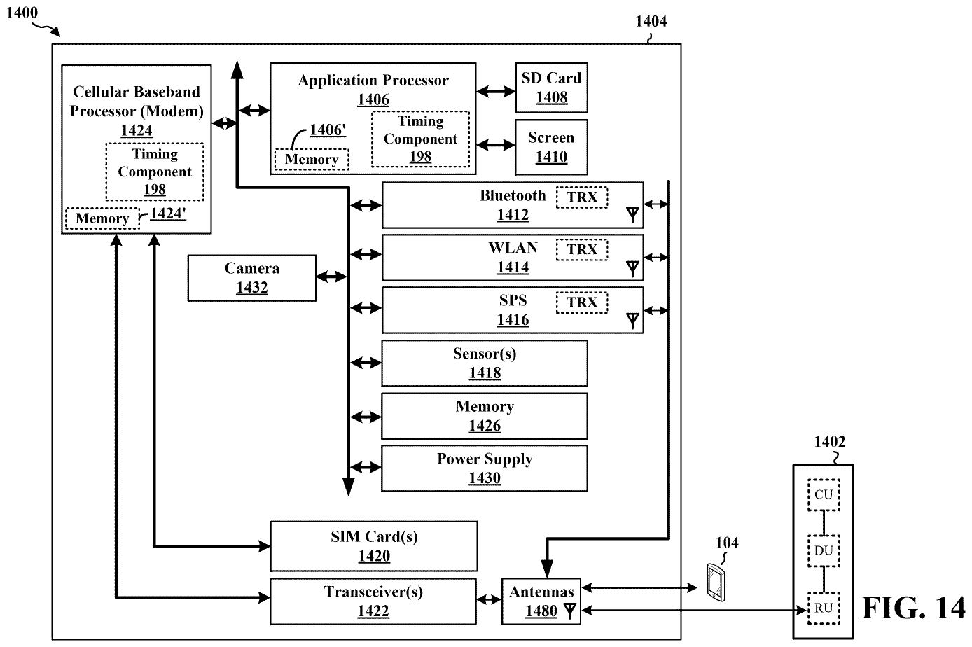

FIG. 14 is a diagram 1400 illustrating an example of a hardware implementation for an apparatus 1404. The apparatus 1404 may be a UE, a component of a UE, or may implement UE functionality. In some aspects, the apparatus1404 may include a cellular baseband processor 1424 (also referred to as a modem) coupled to one or more transceivers 1422 (e.g., cellular RF transceiver). The cellular baseband processor 1424 may include on-chip memory 1424′. In some aspects, the apparatus 1404 may further include one or more subscriber identity modules (SIM) cards 1420 and an application processor 1406 coupled to a secure digital (SD) card 1408 and a screen 1410. The application processor 1406 may include on-chip memory 1406′. In some aspects, the apparatus 1404 may further include a Bluetooth module 1412, a WLAN module 1414, an SPS module 1416 (e.g., GNSS module), one or more sensor modules 1418 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1426, a power supply 1430, and/or a camera 1432. The Bluetooth module 1412, the WLAN module 1414, and the SPS module 1416 may include an on-chip transceiver (TRX) (or in some cases, just a receiver (RX)). The Bluetooth module 1412, the WLAN module 1414, and the SPS module 1416 may include their own dedicated antennas and/or utilize the antennas 1480 for communication. The cellular baseband processor 1424 communicates through the transceiver(s) 1422 via one or more antennas 1480 with the UE 104 and/or with an RU associated with a network entity 1402. The cellular baseband processor 1424 and the application processor 1406 may each include a computer-readable medium/memory 1424′, 1406′, respectively. The additional memory modules 1426 may also be considered a computer-readable medium/memory. Each computer-readable medium/memory 1424′, 1406′, 1426 may be non-transitory. The cellular baseband processor 1424 and the application processor 1406 are each responsible for general processing, including the execution of software stored on the computer-readable medium/memory. The software, when executed by the cellular baseband processor 1424/application processor 1406, causes the cellular baseband processor 1424/application processor 1406 to perform the various functions described supra. The computer-readable medium/memory may also be used for storing data that is manipulated by the cellular baseband processor 1424/application processor 1406 when executing software. The cellular baseband processor 1424/application processor 1406 may be a component of the UE 350 and may include the memory 360 and/or at least one of the TX processor 368, the RX processor 356, and the controller/processor 359. In one configuration, the apparatus 1404 may be a processor chip (modem and/or application) and include just the cellular baseband processor 1424 and/or the application processor 1406, and in another configuration, the apparatus 1404 may be the entire UE (e.g., see 350 of FIG. 3) and include the additional modules of the apparatus 1404.

As discussed supra, the component 198 is configured to determine one or more DL RSs for a corresponding CORESET pool index value; determine a downlink reference timing associated with the CORESET pool index value based at least on at least one path corresponding to the one or more DL RSs; and transmit an uplink communication associated with the CORESET pool index value based on the downlink reference timing. The component 198 may be within the cellular baseband processor 1424, the application processor 1406, or both the cellular baseband processor 1424 and the application processor 1406. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. As shown, the apparatus 1404 may include a variety of components configured for various functions. In one configuration, the apparatus 1404, and in particular the cellular baseband processor 1424 and/or the application processor 1406, includes means for determining one or more DL RSs for a corresponding CORESET pool index value. The apparatus includes means for determining a downlink reference timing associated with the CORESET pool index value based at least on at least one path corresponding to the one or more DL RSs. The apparatus includes means for transmitting an uplink communication associated with the CORESET pool index value based on the downlink reference timing. The means may be the component 198 of the apparatus 1404 configured to perform the functions recited by the means. As described supra, the apparatus 1404 may include the TX processor 368, the RX processor 356, and the controller/processor 359. As such, in one configuration, the means may be the TX processor 368, the RX processor 356, and/or the controller/processor 359 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. If a first apparatus receives data from or transmits data to a second apparatus, the data may be received/transmitted directly between the first and second apparatuses, or indirectly between the first and second apparatuses through a set of apparatuses. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a UE, comprising determine one or more DL RSs for a corresponding CORESET pool index value; determine a downlink reference timing associated with the CORESET pool index value based at least on at least one path corresponding to the one or more DL RSs; and transmit an uplink communication associated with the CORESET pool index value based on the downlink reference timing.

Aspect 2 is the method of aspect 1, further includes that the downlink reference timing is based on the at least one path being a strongest path that corresponds to the one or more DL RSs or an earliest path detected that corresponds to the one or more DL RSs of a corresponding downlink frame.

Aspect 3 is the method of any of aspects 1 and 2, further includes that the one or more DL RSs associated with the corresponding CORESET pool index value is based on a set of activated TCI states associated with the corresponding CORESET pool index value.

Aspect 4 is the method of any of aspects 1-3, further includes that the set of activated TCI states associated with the corresponding CORESET pool index value is based on activated TCI states of PDSCH associated with the CORESET pool index value.

Aspect 5 is the method of any of aspects 1-4, further includes that the set of activated TCI states associated with the corresponding CORESET pool index value is based on activated TCI states of CORESETs associated with the CORESET pool index value.

Aspect 6 is the method of any of aspects 1-5, further includes that the set of activated TCI states associated with the corresponding CORESET pool index value is based on a union of activated TCI states of PDSCH associated with the CORESET pool index value and activated TCI states of CORESETs associated with the CORESET pool index value.

Aspect 7 is the method of any of aspects 1-6, further includes that the one or more DL RSs comprises a QCL type set to a first setting, wherein the first setting comprises a typeD setting.

Aspect 8 is the method of any of aspects 1-7, further includes that the one or more DL RSs associated with the corresponding CORESET pool index value is based on a TCI state associated with the corresponding CORESET pool index value.

Aspect 9 is the method of any of aspects 1-8, further includes that the TCI state associated with the corresponding CORESET pool index value is based on at least one of, an activated TCI state having a first TCI state within a plurality of activated TCI states of PDSCH associated with the CORESET pool index value, wherein the first TCI state is the TCI state with lowest or highest TCI state ID among the plurality of activated TCI states of PDSCH associated with the CORESET pool index value, an activated TCI state of a CORESET having a first CORESET ID associated with the CORESET pool index value, wherein the first CORESET identifier is the lowest or highest CORESET identifier associated with the CORESET pool index, or activated TCI states of PDCCH receptions in CORESETs associated with the CORESET pool index value and associated with search space sets having a shortest monitoring periodicity.

Aspect 10 is the method of any of aspects 1-9, further includes that the one or more DL RSs comprises a QCL type set to a first setting, wherein the first setting comprises a typeD setting.

Aspect 11 is the method of any of aspects 1-10, further includes that the set of activated TCI states associated with the corresponding CORESET pool index value comprises of activated TCI states associated with the corresponding CORESET pool index in a first slot of a downlink frame, if a MAC CE activation command to update the set of activated transmission configuration indication states is applied in a middle of the downlink frame.

Aspect 12 is the method of any of aspects 1-11, further includes that the downlink reference timing is based on a SSB received during a PRACH procedure, if a MAC-CE activation command for PDSCH that corresponds to a CORESET pool index or a MAC-CE activation command for any CORESET associated with the CORESET pool index value is not received.

Aspect 13 is the method of any of aspects 1-12, further includes that the downlink reference timing is based on a strongest or an earliest path of a corresponding downlink frame detected from the SSB received during the PRACH procedure.

Aspect 14 is the method of any of aspects 1-13, further includes that an association between the PRACH procedure and the CORESET pool index value is based on at least one of a fixed rule, where a first subset of SSBs are associated with a first CORESET pool index value and a second subset of SSBs are associated with a second CORESET pool index value, is configured via RRC signaling, or is based at least on a CORESET pool index of the CORESET in which a PDCCH that triggers the PRACH procedure is received.

Aspect 15 is the method of any of aspects 1-14, further includes that an additional PCI associated with activated TCI states of at least one of a PDCCH or a PDSCH for the CORESET pool index value is changed during a downlink frame.

Aspect 16 is the method of any of aspects 1-15, further includes that the downlink reference timing for the CORESET pool index value is based on the additional PCI associated with the CORESET pool index in a first slot of the downlink frame.

Aspect 17 is the method of any of aspects 1-16, further includes that the downlink reference timing for the CORESET pool index value is based on a downlink reference timing of the additional PCI associated with the CORESET pool index, wherein the downlink reference timing of the additional associated with the CORESET pool index is based on at least one of a strongest path or an earliest path detected from the DL RSs associated with the additional PCI.

Aspect 18 is the method of any of aspects 1-17, further includes that the DL RSs associated with the additional PCI is based on a set of activated TCI states associated with the additional PCI.

Aspect 19 is the method of any of aspects 1-18, further includes that the set of activated TCI states associated with the additional PCI is based on at least one of activated TCI states of the PDSCH associated with the additional PCI, based on activated TCI states of CORESETs associated with the additional PCI, or based on a union of activated TCI states of the PDSCH and CORESETs associated with the additional PCI.

Aspect 20 is the method of any of aspects 1-19, further includes that the DL RSs comprises a QCL type set to a first setting, wherein the first setting comprises a typeD setting.

Aspect 21 is the method of any of aspects 1-20, further includes that the DL RSs associated with the additional PCI is based on a TCI state associated with the additional PCI.

Aspect 22 is the method of any of aspects 1-21, further includes that the TCI state associated with the additional PCI is based on at least one of an activated TCI state having a first TCI state ID within a plurality of activated TCI state IDs of a PDSCH associated with the PCI, based on the activated TCI state of a CORESET having a first CORESET ID within a plurality of CORESET IDs having activated TCI states associated with the PCI, or based on the activated TCI state for PDCCH receptions in CORESETs having activated TCI states associated with the additional PCI and the search space sets having a shortest monitoring periodicity.

Aspect 23 is the method of any of aspects 1-22, further includes that the DL RSs comprises a QCL type set to a first setting, wherein the first setting comprises a typeD setting.

Aspect 24 is an apparatus for wireless communication at a UE including at least one processor coupled to a memory and at least one transceiver, the at least one processor configured to implement any of Aspects 1-23.

Aspect 25 is an apparatus for wireless communication at a UE including means for implementing any of Aspects 1-23.

Aspect 26 is a computer-readable medium storing computer executable code, where the code when executed by a processor causes the processor to implement any of Aspects 1-23.

What is claimed is:

1. An apparatus for wireless communication at a user equipment (UE), comprising:
a memory; and
at least one processor coupled to the memory and, based at least in part on information stored in the memory, the at least one processor is configured to:
determine one or more downlink reference signals (DL RSs) for a corresponding control resource set (CORESET) pool index value;
determine a downlink reference timing associated with the CORESET pool index value based at least on at least one path corresponding to the one or more DL RSs; and
transmit an uplink communication associated with the CORESET pool index value based on the downlink reference timing.

2. The apparatus of claim 1, further comprising a transceiver coupled to the at least one processor.

3. The apparatus of claim 1, wherein the downlink reference timing is based on the at least one path being a strongest path that corresponds to the one or more DL RSs or an earliest path detected that corresponds to the one or more DL RSs of a corresponding downlink frame.

4. The apparatus of claim 1, wherein the one or more DL RSs associated with the corresponding CORESET pool index value is based on a set of activated transmission configuration indication (TCI) states associated with the corresponding CORESET pool index value.

5. The apparatus of claim 4, wherein the set of activated TCI states associated with the corresponding CORESET pool index value is based on activated TCI states of physical downlink shared channel (PDSCH) associated with the CORESET pool index value.

6. The apparatus of claim 4, wherein the set of activated TCI states associated with the corresponding CORESET pool index value is based on activated TCI states of CORESETs associated with the CORESET pool index value.

7. The apparatus of claim 4, wherein the set of activated TCI states associated with the corresponding CORESET pool index value is based on a union of activated TCI states of physical downlink shared channel (PDSCH) associated with the CORESET pool index value and activated TCI states of CORESETs associated with the CORESET pool index value.

8. The apparatus of claim 4, wherein the one or more DL RSs comprises a quasi co-location (QCL) type set to a first setting, wherein the first setting comprises a typeD setting.

9. The apparatus of claim 1, wherein the one or more DL RSs associated with the corresponding CORESET pool index value is based on a TCI state associated with the corresponding CORESET pool index value.

10. The apparatus of claim 9, wherein the TCI state associated with the corresponding CORESET pool index value is based on at least one of,
an activated TCI state having a first TCI state within a plurality of activated TCI states of physical downlink shared channel (PDSCH) associated with the CORESET pool index value, wherein the first TCI state is the TCI state with lowest or highest TCI state ID among the plurality of activated TCI states of PDSCH associated with the CORESET pool index value,
an activated TCI state of a CORESET having a first CORESET identifier (ID) associated with the CORESET pool index value, wherein the first CORESET identifier is the lowest or highest CORESET identifier associated with the CORESET pool index, or
activated TCI states of physical downlink control channel (PDCCH) receptions in CORESETs associated with the CORESET pool index value and associated with search space sets having a shortest monitoring periodicity.

11. The apparatus of claim 9, wherein the one or more DL RSs comprises a quasi co-location (QCL) type set to a first setting, wherein the first setting comprises a typeD setting.

12. The apparatus of claim 4, wherein the set of activated transmission configuration indication (TCI) states associated with the corresponding CORESET pool index value comprises activated TCI states associated with the corresponding CORESET pool index in a first slot of a downlink frame, if a MAC CE activation command to update the set of activated transmission configuration indication states is applied in a middle of the downlink frame.

13. The apparatus of claim 1, wherein the downlink reference timing is based on a synchronization signal block (SSB) received during a physical random access channel (PRACH) procedure, if a medium access control (MAC) control element (CE) (MAC-CE) activation command for physical downlink shared channel (PDSCH) that corresponds to a CORESET pool index or a MAC-CE activation command for any CORESET associated with the CORESET pool index value is not received.

14. The apparatus of claim 13, wherein the downlink reference timing is based on a strongest or an earliest path of a corresponding downlink frame detected from the SSB received during the PRACH procedure.

15. The apparatus of claim 14, wherein an association between the PRACH procedure and the CORESET pool index value is based on at least one of a fixed rule, where a first subset of SSBs are associated with a first CORESET pool index value and a second subset of SSBs are associated with a second CORESET pool index value, is configured via radio resource control (RRC) signaling, or is based at least on a CORESET pool index of the CORESET in which a physical downlink control channel (PDCCH) that triggers the PRACH procedure is received.

16. The apparatus of claim 1, wherein an additional physical cell identifier (PCI) associated with activated transmission configuration indication (TCI) states of at least one of a physical downlink control channel (PDCCH) or a physical downlink shared channel (PDSCH) for the CORESET pool index value is changed during a downlink frame.

17. The apparatus of claim 16, wherein the downlink reference timing for the CORESET pool index value is based on the additional PCI associated with the CORESET pool index in a first slot of the downlink frame.

18. The apparatus of claim 16, wherein the downlink reference timing for the CORESET pool index value is based on a downlink reference timing of the additional PCI associated with the CORESET pool index, wherein the downlink reference timing of the additional associated with the CORESET pool index is based on at least one of a strongest path or an earliest path detected from the DL RSs associated with the additional PCI.

19. The apparatus of claim 18, wherein the DL RSs associated with the additional PCI is based on a set of activated transmission configuration indication (TCI) states associated with the additional PCI.

20. The apparatus of claim 19, wherein the set of activated TCI states associated with the additional PCI is based on at least one of activated TCI states of the PDSCH associated with the additional PCI, based on activated TCI states of CORESETs associated with the additional PCI, or based on a union of activated TCI states of the PDSCH and CORESETs associated with the additional PCI.

21. The apparatus of claim 19, wherein the DL RSs comprises a quasi co-location (QCL) type set to a first setting, wherein the first setting comprises a typeD setting.

22. The apparatus of claim 18, wherein the DL RSs associated with the additional PCI is based on a TCI state associated with the additional PCI.

23. The apparatus of claim 22, wherein the TCI state associated with the additional PCI is based on at least one of an activated TCI state having a first TCI state identifier (ID) within a plurality of activated TCI state IDs of a PDSCH associated with the PCI, based on the activated TCI state of a CORESET having a first CORESET ID within a plurality of CORESET IDs having activated TCI states associated with the PCI, or based on the activated TCI state for PDCCH receptions in CORESETs having activated TCI states associated with the additional PCI and the search space sets having a shortest monitoring periodicity.

24. The apparatus of claim 22, wherein the DL RSs comprises a quasi co-location (QCL) type set to a first setting, wherein the first setting comprises a typeD setting.

25. A method of wireless communication of a user equipment (UE), comprising:
determining one or more downlink reference signals (DL RSs) for a corresponding control resource set (CORESET) pool index value;
determining a downlink reference timing associated with the CORESET pool index value based at least on at least one path corresponding to the one or more DL RSs; and
transmitting an uplink communication associated with the CORESET pool index value based on the downlink reference timing.

26. The method of claim 25, wherein the one or more DL RSs associated with the corresponding CORESET pool index value is based on a set of activated transmission configuration indication (TCI) states associated with the corresponding CORESET pool index value.

27. The method of claim 25, wherein the one or more DL RSs associated with the corresponding CORESET pool index value is based on a TCI state associated with the corresponding CORESET pool index value.

28. The method of claim 25, wherein the downlink reference timing is based on a synchronization signal block (SSB) received during a physical random access channel (PRACH) procedure, if a medium access control (MAC) control element (CE) (MAC-CE) activation command for physical downlink shared channel (PDSCH) that corresponds to a CORESET pool index or a MAC-CE activation command for any CORESET associated with the CORESET pool index value is not received.

29. An apparatus for wireless communication at a user equipment (UE), comprising:
means for determining one or more downlink reference signals (DL RSs) for a corresponding control resource set (CORESET) pool index value;
means for determining a downlink reference timing associated with the CORESET pool index value based at least on at least one path corresponding to the one or more DL RSs; and
means for transmitting an uplink communication associated with the CORESET pool index value based on the downlink reference timing.

30. A computer-readable medium storing computer executable code at a user equipment (UE), the code when executed by a processor causes the processor to:
determine one or more downlink reference signals (DL RSs) for a corresponding control resource set (CORESET) pool index value;
determine a downlink reference timing associated with the CORESET pool index value based at least on at least one path corresponding to the one or more DL RSs; and
transmit an uplink communication associated with the CORESET pool index value based on the downlink reference timing.
